(19) United States
(12) Patent Application Publication
(10) Pub. No.: US 2024/0030469 A1
(43) Pub. Date: Jan. 25, 2024

(54) ANODE POISON REDUCTION SYSTEM AND METHOD FOR FUEL CELL VEHICLE

(71) Applicants: Hyundai Motor Company, Seoul (KR); Kia Corporation, Seoul (KR)

(72) Inventors: Byeong Eun CHO, Seoul (KR); Hyun Jae LEE, Seoul (KR); Jun Yeol PAEK, Seoul (KR)

(73) Assignees: Hyundai Motor Company, Seoul (KR); Kia Corporation, Seoul (KR)

(21) Appl. No.: 18/099,429

(22) Filed: Jan. 20, 2023

(30) Foreign Application Priority Data
Jul. 19, 2022 (KR) 10-2022-0089091

(51) Int. Cl. H01M 8/04664; H01M 8/04111; H01M 8/0444; H01M 8/04492; H01M 8/04537; H01M 8/04746; H01M 8/04858; H01M 8/04223

(52) U.S. Cl. CPC H01M 8/04671; H01M 8/04111; H01M 8/04447; H01M 8/045; H01M 8/04582; H01M 8/04753; H01M 8/04776; H01M 8/04932; H01M 8/04902; H01M 8/04552; H01M 8/04231; H01M 2250/20

(57) ABSTRACT

An anode poison reduction system and method for a fuel cell vehicle. The system includes a monitoring device configured to monitor a state and performance of a fuel cell, and a controller configured to perform first control of controlling output of the fuel cell or air supply when an anode poisoning possibility condition is satisfied as a monitoring result by the monitoring device, and configured to perform second control of supplying air in the air line to the anode through the connection line when an anode poisoning generation condition is satisfied.

### CROSS REFERENCE TO RELATED APPLICATION

The present application claims priority to Korean Patent Application No. 10-2022-0089091, filed on Jul. 19, 2022, the entire contents of which is incorporated herein for all purposes by this reference.

### BACKGROUND

### Technical Field

The present disclosure relates to an anode poison reduction system and method for a fuel cell vehicle, the system and method being economical because it is possible to relatively accurately determine or prevent poisoning even without a specific sensor by determining a situation, in which an anode catalyst may be poisoned with CO (carbon monoxide), on the basis of driving data of a hydrogen fuel cell vehicle, it is possible to prevent CO poisoning by appropriately controlling driving of the vehicle, and it is possible to recover an anode from poisoning by supplying air to the anode even without adding a specific line when determining that the performance of the anode has decreased due to poisoning.

### DESCRIPTION OF THE RELATED ART

Recently, eco-friendly vehicles such as an electric vehicle, a fuel cell vehicle, or the like are being increasingly demanded and developed due to environmental problems.

In a fuel cell vehicle of such eco-friendly vehicles, a fuel cell composed of an anode and a cathode provides driving energy for the vehicle and is accompanied by a chemical reaction, so the fuel cell should be carefully managed to prevent deterioration thereof.

Even a very small amount of CO (carbon monoxide) may exist in a fuel cell due to impurities in fuel (hydrogen gas) that is supplied or incomplete combustion of a carbon support in an electrode catalyst during driving. In this case, CO is adsorbed on platinum at the anode with low potential, which may cause a problem of reducing the active area of a catalyst and severely impeding an electrochemical reaction.

In order to prevent or solving the situation in which an anode catalyst of a fuel cell is poisoned by adsorption of CO during driving, method of (1) using an alloy catalyst such as Pt—Ru, (2) increasing a driving temperature, and (3) supplying air to the anode (for recovery when poisoned) have been proposed in the related art.

However, the method 1 of these methods needs an expensive catalyst more than the catalysts applied to existing commercial vehicles, so there is a problem that this method is not suitable for mass-produced hydrogen fuel cell vehicles. The method 2 requires higher temperature (150° C. or more) than the usual driving temperature range (60˜80° C.) of vehicles, so there is a problem that this method is difficult to apply.

Further, according to the method 3, it is difficult to configure a separate anode air supply line in an air supply system in a vehicle and carbon corrosion may be generated at a cathode due to formation of an H₂/O₂ interface other than adhesion/separation of CO, so there is a problem that this method is also not suitable.

The description provided above as a related art of the present disclosure is just for helping the understanding the background of the present disclosure and should not be construed as being included in the related art known by those skilled in the art.

### SUMMARY

The present disclosure has been made in an effort to solve the problems described above and an objective of the present disclosure is to provide an anode poison reduction system and method for a fuel cell vehicle, the system and method being economical because it is possible to relatively accurately determine or prevent poisoning even without a specific sensor by determining a situation, in which an anode catalyst may be poisoned with CO, on the basis of driving data of a hydrogen fuel cell vehicle, it is possible to prevent CO poisoning by appropriately controlling driving of the vehicle, and it is possible to recover an anode from poisoning by supplying air to the anode even without adding a specific line when determining that the performance of the anode has decreased due to poisoning.

An anode poison reduction system for a fuel cell vehicle according to the present disclosure for achieve the objectives includes: an air line to connect to a cathode of a fuel cell; a hydrogen line to connect to an anode of the fuel cell and including a connection line to connect an outlet of the anode and the air line to each other; a monitoring device configured to monitor a state and performance of the fuel cell; and a controller configured to perform first control of controlling output of the fuel cell or air supply when, based on a monitoring result by the monitoring device, an anode poisoning possibility condition is satisfied, and configured to perform second control of supplying air in the air line to the anode through the connection line when an anode poisoning generation condition is satisfied.

The anode poison reduction system may further include a compressor disposed in the air line and configured to pressurize and supply air to the cathode, and an air valve disposed in the air line and configured to adjust air flow in the air line, where the connection line has a first end to connect to the outlet of the anode and a second end to connect to a point between the air valve and the compressor in the air line.

The controller may supply air to the outlet of the anode through the connection line by operating the compressor and closing the air valve when performing the second control.

The anode poison reduction system may further include a compressor disposed in the air line and configured to pressurize and supply air to the cathode, and a 3-way valve disposed in the air line and having a first way to connect to the cathode, a second way to connect to the compressor, and a third way to connect to the connection line, where the controller may supply air to the outlet of the anode through the connection line by operating the compressor and controlling the 3-way valve when performing the second control.

The monitoring device may be an anode hydrogen concentration detector or an anode humidity detector or a fuel cell request current detector.

The controller may determine the anode poisoning possibility condition on a basis of relative humidity of the anode or hydrogen concentration of the anode or a fuel cell request current.

The controller may perform the first control when the anode poisoning possibility condition exceeds a reference time or a reference time ratio.

The controller may increase pressure or a flow rate of air that is supplied to the cathode through the air line in the first control.

The controller may control power generation of the fuel cell by changing a fuel cell request current to oscillate in the first control.

The controller, in the first control, may increase pressure or a flow rate of air that is supplied to the cathode through the air line, and may selectively change a request current of the fuel cell to oscillate, depending on a charged amount of a battery that provides driving power for the vehicle.

The anode poisoning generation condition may be determined on a basis of a decline in an inclination of an output voltage of the fuel cell.

The controller may determine the anode poisoning generation condition when a decline in an inclination of an output voltage of the fuel cell is larger than a reference inclination in a reference current density period.

The controller may perform the second control when the anode poisoning generation condition is satisfied and operation of the fuel cell is stopped.

The anode poison reduction system may further include a compressor, where the connection line may include at least one of a drain valve and a purge valve, and the controller drives the compressor such that air is supplied to the outlet of the anode while flowing backward through the drain valve or the purge valve when performing the second control.

An anode poison reduction method for a fuel cell vehicle of the present disclosure includes: monitoring, by a monitoring device, a state and performance of a fuel cell; determining, by a controller, an anode poisoning possibility condition and performing, by the controller, first control of controlling output of the fuel cell or air supply when the anode poisoning possibility condition is satisfied; and determining, by the controller, an anode poisoning generation condition and performing, by the controller, second control of supplying air in an air line to an anode through a connection line when the anode poisoning generation condition is satisfied.

According to the anode poison reduction system and method for a fuel cell vehicle of the present disclosure, the system and method are economical because it is possible to relatively accurately determine or prevent poisoning even without a specific sensor by determining a situation, in which an anode catalyst may be poisoned with CO, on the basis of driving data of a hydrogen fuel cell vehicle, it is possible to prevent CO poisoning by appropriately controlling driving of the vehicle, and it is possible to recover an anode from poisoning by supplying air to the anode even without adding a specific line when determining that the performance of the anode has decreased due to poisoning.

### BRIEF DESCRIPTION OF THE DRAWINGS

The above and other objectives, features and other advantages of the present disclosure will be more clearly understood from the following detailed description when taken in conjunction with the accompanying drawings, in which:

FIGS. 1 and 2 are configuration diagrams of an anode poison reduction system for a fuel cell vehicle according to an embodiment of the present disclosure;

FIG. 3 is a flowchart of an anode poison reduction method for a fuel cell vehicle according to an embodiment of the present disclosure; and

FIGS. 4 to 7 are graphs showing the effects of the anode poison reduction system for a fuel cell vehicle according to an embodiment of the present disclosure.

### DETAILED DESCRIPTION

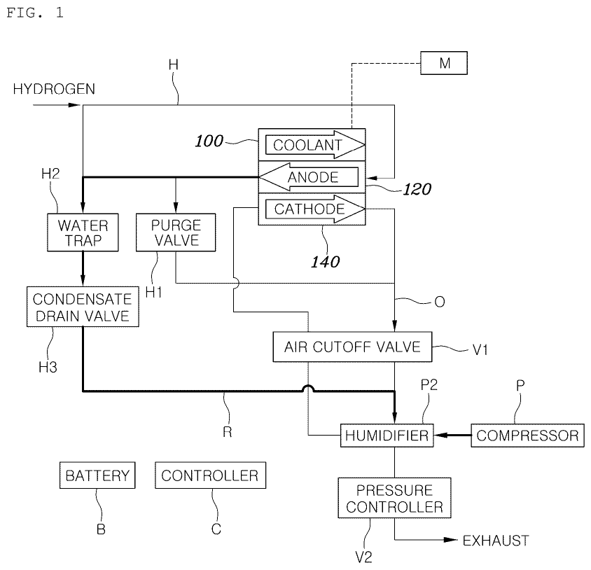

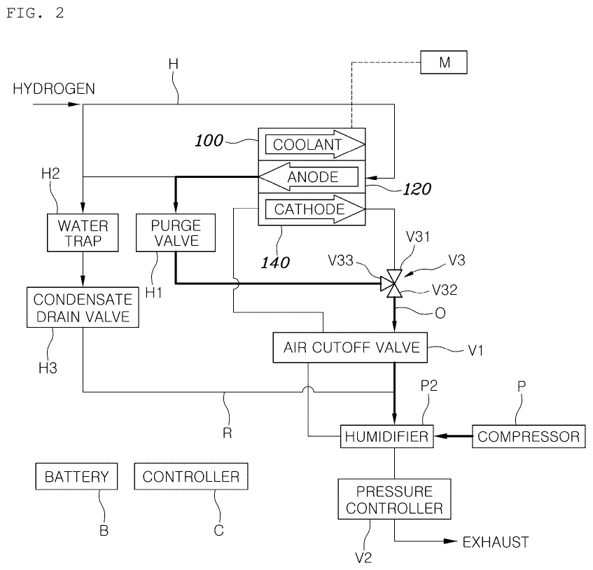

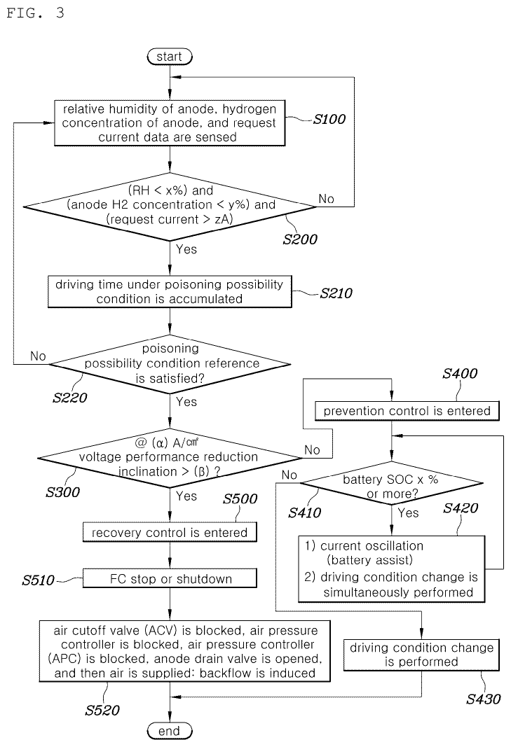

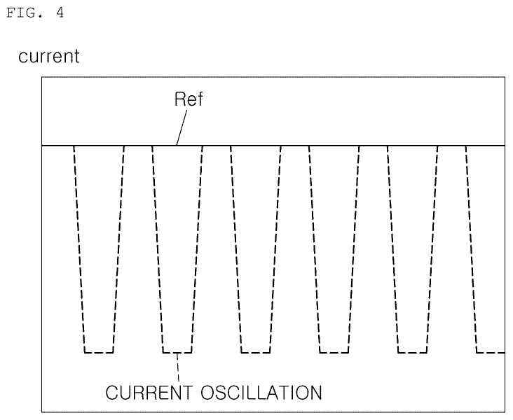

FIGS. 1 and 2 are configuration diagrams of an anode poison reduction system for a fuel cell vehicle according to an embodiment of the present disclosure, FIG. 3 is a flowchart of an anode poison reduction method for a fuel cell vehicle according to an embodiment of the present disclosure, and FIGS. 4 to 7 are graphs showing the effects of the anode poison reduction system for a fuel cell vehicle according to an embodiment of the present disclosure.

An anode poison reduction system and method for a fuel cell vehicle according to the present disclosure is for preventing performance reduction and deterioration of a fuel cell by early preventing a phenomenon in which an anode catalyst of a fuel cell is poisoned with CO during driving and by making recovering and driving possible even when poisoning proceeds.

In particular, it is possible to accurately predict or sense poisoning on the basis of existing driving data even without adding specific sensors or parts, and solve poisoning without influencing drivability even when poisoning is generated.

It is exemplified to apply the fuel cell system of the present disclosure to a vehicle, but the fuel cell system is not necessarily limited to vehicles.

FIG. 1 is a configuration diagram of an anode poison reduction system for a fuel cell vehicle according to an embodiment of the present disclosure. An automotive fuel cell is composed of an anode 120 and a cathode 140 and cooling water (coolant) that cools the fuel cell while flowing. Hydrogen is injected into the anode 120, air is injected into the cathode 140, and power is generated by chemical action of the hydrogen and the oxygen in the air.

An anode poison reduction system for a fuel cell vehicle according to the present disclosure includes: an air line O connected to a cathode 140 of a fuel cell 100; a hydrogen line H connected to the anode 120 of the fuel cell 100 and having a connection line R connecting an outlet of the anode and the air line O to each other; a monitoring device M monitoring the state and performance of the fuel cell 100; and a controller C performing first control of controlling output of the fuel cell or air supply when an anode poisoning possibility condition is satisfied as the monitoring result by the monitoring device M and performing second control of supplying air in the air line O to the anode 120 through the connection line R when an anode poisoning generation condition is satisfied.

The cathode 140 is connected to the air line O, and a compressor P pressurizing and supplying air to the cathode 140 and air valves V1 and V2 adjusting air flow in the air line O are disposed in the air line O.

The hydrogen line H is connected to the anode 120 and the anode 120 is supplied with hydrogen from a hydrogen tank through the hydrogen line H.

In the present disclosure, the connection line R is disposed at the hydrogen line H and connects the outlet of the anode 120 and the air line O to each other.

As shown in the figures, a water trap H2, a drain valve H3, and a purge valve H1 are disposed in the connection line R. Exhaust gas discharged from the anode contains remaining hydrogen and moisture, the moisture is stored in the water trap H2, and water is discharged by opening the drain valve H3. The discharged water flows into a humidifier P2 in the air line O and supplies moisture to the air flowing to the cathode 140, whereby the fuel cell is maintained in a good condition.

Meanwhile, hydrogen discharged from the anode 120 is discharged to the humidifier P2 when the purge valve H1 is opened, whereby the hydrogen may flow into the cathode 140 or may be discharged.

In detail, when the anode poisoning possibility condition is satisfied as the result of monitoring the fuel cell by the monitoring device M that monitors the state and performance of the fuel cell, the controller C performs the first control of controlling output of the fuel cell or air supply.

When even a very small amount of CO (carbon monoxide) exists in the fuel cell due to impurities in fuel (hydrogen gas) that is supplied or incomplete combustion of a carbon support in an electrode catalyst during driving, CO is adsorbed on platinum at the anode with low potential, which causes a problem of reducing the active area of a catalyst and severely impeding an electrochemical reaction.

Accordingly, a situation in which such a problem may be generated is sensed in advance, and early control is performed to prevent the anode from being poisoned when this situation is sensed so that poisoning can be prevented.

In detail, the monitoring device M may be an anode hydrogen concentration detector or an anode humidity detector or a fuel cell request current detector.

The controller C can determine the anode poisoning possibility condition on the basis of relative humidity of the anode or hydrogen concentration of the anode or a fuel cell request current collected by the monitoring device M. When a request current that is required for the fuel cell is maintained at a high level for a predetermined time or more with the relative humidity HR of the anode high and the hydrogen concentration of the anode low, it is determined as an environment in which poisoning of the anode can be generated. These determination factors are factors derived through experiments.

When these conditions are satisfied, the controller C considers the anode poisoning possibility condition satisfied and performs the first control of controlling output of the fuel cell or air supply. By performing the first control, the anode gets out of a situation in which the anode may be poisoned and it is possible to prevent in advance performance reduction of deterioration of the fuel cell.

The controller C can prevent poisoning by controlling the air line O of the fuel cell. That is, the controller C can increase the pressure or the flow rate of the air that is supplied to the cathode 140 through the air line O in the first control. Accordingly, crossover of the air is generated, thereby preventing poisoning of the anode.

Alternately, the controller C can control power generation of the fuel cell 100 by changing the request current of the fuel cell 100 to have oscillation in the first control. That is, the controller C increases and decreases the request current, which is a control value of the fuel cell, to have oscillation, thereby increasing variation of a generated current and a supplied gas. Accordingly, crossover of oxygen is further generated, thereby being able to prevent poisoning of the anode.

In particular, the controller C, in the first control, can increase the pressure or the flow rate of the air that is supplied to the cathode 140 through the air line O and can selectively change the request current of the fuel cell to have oscillation, depending on the charged amount of a battery B that provides driving power for the vehicle. That is, when oscillation is generated in the request current, it is required to appropriately manage the fuel cell and maintain the entire performance of the vehicle by providing power through cooperative control of the battery B of the vehicle in order to satisfy total output requested by the vehicle.

Meanwhile, when the anode poisoning generation condition is satisfied, the controller C performs the second control of supplying air in the air line O to the anode 120 through the connection line R. To this end, as shown in FIG. 1, the connection line R may be connected at a first end to the outlet of the anode 120 and at a second end to a point between the air valves V1 and V2 and the compressor P in the air line.

In this case, the controller C can supply air to the outlet of the anode 120 through the connection line R by operating the compressor P and closing the air valves V1 and V2 when performing the second control. The air valves V1 and V2, as shown in FIGS. 1 and 2, may be a cutoff valve V1 and a pressure controller V2.

When performing the second control, the controller C closes both the cutoff valve V1 and the pressure controller V2 and drives the compressor P, whereby air flows backward through the drain valve H3 and the water trap H2 and is then supplied to the anode 120 through the outlet of the anode 120. This case corresponds to recovering a poisoned situation by actively supplying hydrogen to the anode 120. Further, a specific additional line or equipment for supplying hydrogen to the anode 120 is not needed, so there is even an advantage that this configuration is economical and can be immediately applied to currently mass-produced vehicles by changing only a control logic.

In some embodiments, the controller C may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

Meanwhile, FIG. 2 shows another embodiment, in which a compressor P, which pressurizes and supplies air to the cathode 140, and a 3-way valve V3 are disposed in the air line O, a first way V31 of the 3-way valve V3 is connected to the cathode 140, a second way V32 thereof is connected to the compressor P, a third way V33 thereof is connected to the connection line R, and the controller C can supply air to the outlet of the anode 120 through the connection line R by operating the compressor P and controlling the 3-way valve V3 when performing the second control.

In this case, by controlling the 3-way valve V3, the air supplied from the compressor P flows backward to the purge valve H1 through the second way V32 and the third way V33 of the 3-way valve V3 and is then supplied to the outlet of the anode 120.

Meanwhile, the anode poisoning generation condition in which poisoning of the anode 120 has proceeded can be determined on the basis of the decline in an inclination of the output voltage of the fuel cell. That is, when the anode 120 has already been poisoned, performance reduction such as a drop of output voltage is generated when the vehicle is driven under the same condition, so whether the anode has been poisoned is determined on the basis of this factor.

In detail, when the decline in an inclination of the output voltage of the fuel cell is larger than a preset reference inclination in a preset reference current density period, the controller C can determine the anode poisoning generation condition.

When the anode poisoning generation condition is satisfied, the controller C can perform the second control when operation of the fuel cell 100 is stopped. That is, since it is difficult to actively supply air to the anode when the fuel cell is in operation, air is supplied backward to the anode with operation of the fuel cell stopped.

FIG. 3 is a flowchart of an anode poison reduction method for a fuel cell vehicle according to an embodiment of the present disclosure. An anode poison reduction method for a fuel cell vehicle of the present disclosure includes: monitoring the state and performance of a fuel cell by means of a monitoring device (S100); determining an anode poisoning possibility condition and performing first control of controlling output of the fuel cell or air supply by means of a controller when the anode poisoning possibility condition is satisfied (S400); and determining an anode poisoning generation condition and performing second control of supplying air in an air line to an anode through a connection line by means of the controller when the anode poisoning generation condition is satisfied (S500).

In detail, artificial driving control for adhesion/separation (supplying air to the anode, etc.) fundamentally has an adverse influence on the durability of a stack, so a process of determining whether to enter prevention/recovery driving is required. Advantageous conditions for formation of CO and adsorption of Pt at an anode may be selected as follows through a relevant test result.
(1) Low relative humidity of anode (RH<x %)
(2) Low hydrogen concentration of anode (concentration <y %)
(3) Driving is continuously maintained with small current amplitude, that is, over a predetermined current (request current >z A)

A state satisfying all of these three conditions may be considered as driving in a poisoning weakness condition (S200). Whether to enter poisoning prevention is determined by accumulating driving time in this state and a satisfaction reference may be divided in detail as follows in accordance with a vehicle kind/predicted driving type, etc. (S210).
(1) Accumulation time type: a case in which the entire accumulation time is t or more (suitable for common vehicles that is driven for a long time & with a predetermined current profile)
(2) Time proportion type: a case in which the ratio of (poisoning weakness driving time)/(entire driving time) is k % or more (suitable for passenger cars that is driven for a short time with a dynamic profile, etc.)

When a poisoning possibility condition is satisfied, the first control is performed (S220 and S400). Current profile/gas supply condition are controlled in the first control and methods are as follows, respectively.
(1) Oscillation of request current (S410, S420): when a request current over a predetermined value is maintained for time t or more, a request current amount is repeatedly decreased up to 0.1 A/cm² within a short time and then recovered to the initial point (current oscillation).

Battery assist is required in a vehicle as much as reduction of a current that is generated in this case, so this control is performed only when the state of charge (SOC) of the battery is over a predetermined level. For reference, the amplitude and frequency of oscillation can be minimized through experiments. It is possible to apply a method of stopping oscillation when a request current is maintained at a predetermined current or less and of restarting oscillation when a high current is maintained.
(2) Driving (gas supply) condition (S430): cathode pressure/SR are increased, in which a stoichiometric ratio (SR) is increased to increase humidification and it is possible to achieve an effect of supplying air in a crossover type to an anode by increasing the SR.

Variations of current generation and gas supply are maximized through this process, so it is possible to induce crossover of oxygen to a cathode, increase the effect of crossover of air by increasing the cathode pressure, and increase humidification by increasing the SR, whereby swelling of an electrolyte membrane is induced. Accordingly, gas crossover can be increased. Further, it is also possible to prevent poisoning of the anode. Meanwhile, the first control is performed until operation of the vehicle is stopped, and if necessary, a loop break condition may be added.

When poisoning has already proceeded, it is required to sense this situation and perform the second control (S300 and S500). When it is determined that a voltage decreases during driving in a driving main current range (when a current density (A/cm²) is maintained as α (in which a reduction (decline) in an inclination over time is β or more), it is determined that an anode catalyst has been poisoned, and recovery driving is performed (S300).

In detail, poisoning recovery driving, which is a method of directly supplying air to an anode, is performed when a fuel cell is in a stop state (FC stop) or a shutdown sequence is entered, and is as follows (S510 and S520).
(1) An air circulation path including a cutoff valve, a pressure controller, etc. of an air supply system is blocked
(2) An anode-side drain valve connected to the air supply system is opened
(3) Air is supplied and guided into an anode through an anode condensate drain line

Air supply amount and time for this method can be optimized for respective vehicle kinds/specifications through advance experiments. Fundamentally, the method is to block the path from the air supply system to the cathode and generate backflow of air through the anode-side drain path, whereby it is possible for a poisoned anode to recover to the normal state. It is not required to add specific parts or lines for this configuration, so there is an advantage that the method can be easily applied to vehicles that are sold at present through mass production.

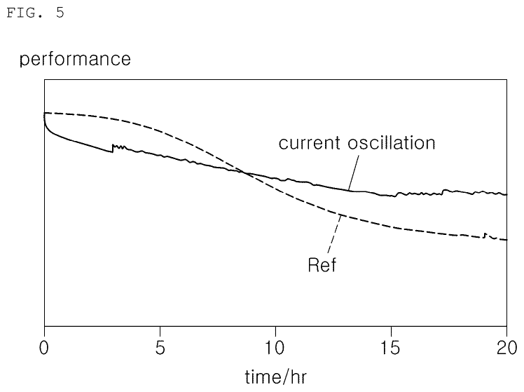

FIG. 4 is a graph comparing a normal request current and an oscillated request current with each other, and the corresponding performance difference is shown as graph in FIG. 5. Comparing the cases in which a vehicle was driven under a static current and current oscillation, it can be seen that performance reduction due to poisoning of an anode catalyst was attenuated when current oscillation is applied.

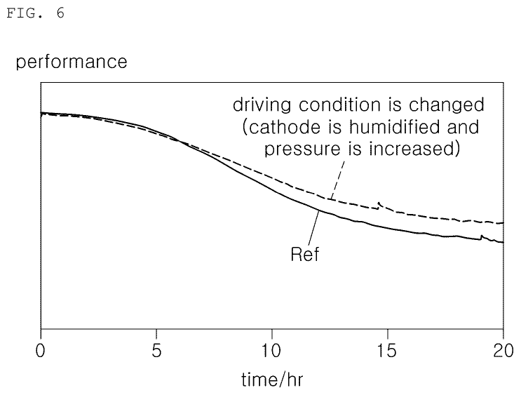

FIG. 6 is a graph showing that poisoning is attenuated by changing driving conditions, and it can be seen that performance reduction was attenuated, as shown in the graph, when cathode was humidified and pressure was increased during driving under a static current.

Accordingly, it is possible to see effects that (a) crossover of oxygen is induced to a cathode by maximizing generation of a current/air supply variation and (b) crossover of oxygen to the cathode increases when an electrolyte membrane is swelled by increasing cathode pressure and humidification. That is, when two driving methods corresponding to a prevention driving condition are applied, performance reduction due to poisoning with CO is prevented in advance, so it is possible to expect an effect of an increase of durability.

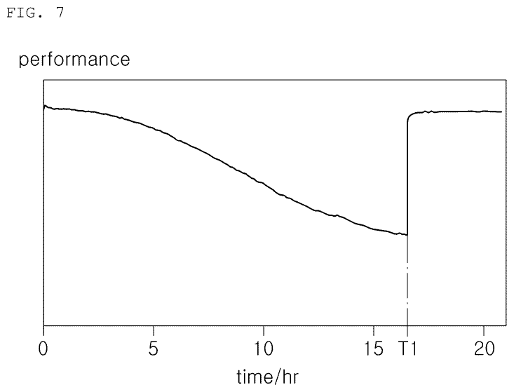

FIG. 7 is a graph showing the result or recovering when poisoning has proceeded, and it can be seen that performance is recovered through a simulation that supplies air to an anode when performance is reduced. That is, it can be seen that, in recovery driving under an anode poisoning generation condition (T1), reduced performance is reversible deterioration, desirable performance can be recovered by supplying air, and it is possible to increase the durability of a fuel cell stack by separating CO adsorbed on an anode-side catalyst through recovery driving in a stop/shutdown state that uses the fact that reduced performance is reversible deterioration.

According to the anode poison reduction system and method for a fuel cell vehicle of the present disclosure, the system and method are economical because it is possible to relatively accurately determine or prevent poisoning even without a specific sensor by determining a situation, in which an anode catalyst may be poisoned with CO, on the basis of driving data of a hydrogen fuel cell vehicle, it is possible to prevent CO poisoning by appropriately controlling driving of the vehicle, and it is possible to recover an anode from poisoning by supplying air to the anode even without adding a specific line when determining that the performance of the anode has decreased due to poisoning.

Although the present disclosure was provided above in relation to specific embodiments shown in the drawings, it is apparent to those skilled in the art that the present disclosure may be changed and modified in various ways without departing from the scope of the present invention, which is described in the following claims.

What is claimed is:

1. An anode poison reduction system for a fuel cell vehicle, the anode poison reduction system comprising:
an air line to connect to a cathode of a fuel cell;
a hydrogen line to connect to an anode of the fuel cell and including a connection line to connect an outlet of the anode and the air line to each other;
a monitoring device configured to monitor a state and performance of the fuel cell; and
a controller configured to:
perform first control of controlling output of the fuel cell or air supply when, based on a monitoring result by the monitoring device, an anode poisoning possibility condition is satisfied, and
perform second control of supplying air in the air line to the anode through the connection line when an anode poisoning generation condition is satisfied.

2. The anode poison reduction system of claim 1, further comprising:
a compressor disposed in the air line and configured to pressurize and supply air to the cathode; and
an air valve disposed in the air line and configured to adjust air flow in the air line,
wherein the connection line has a first end to connect to the outlet of the anode and a second end to connect to a point between the air valve and the compressor in the air line.

3. The anode poison reduction system of claim 2, wherein the controller supplies air to the outlet of the anode through the connection line by operating the compressor and closing the air valve when performing the second control.

4. The anode poison reduction system of claim 1, further comprising:
a compressor disposed in the air line and configured to pressurize and supply air to the cathode; and
a 3-way valve disposed in the air line and having a first way to connect to the cathode, a second way to connect to the compressor, and a third way to connect to the connection line,
wherein the controller supplies air to the outlet of the anode through the connection line by operating the compressor and controlling the 3-way valve when performing the second control.

5. The anode poison reduction system of claim 1, wherein the monitoring device is an anode hydrogen concentration detector or an anode humidity detector or a fuel cell request current detector.

6. The anode poison reduction system of claim 1, wherein the controller determines the anode poisoning possibility condition on a basis of relative humidity of the anode or hydrogen concentration of the anode or a fuel cell request current.

7. The anode poison reduction system of claim 1, wherein the controller performs the first control when the anode poisoning possibility condition exceeds a reference time or a reference time ratio.

8. The anode poison reduction system of claim 1, wherein the controller increases pressure or a flow rate of air that is supplied to the cathode through the air line in the first control.

9. The anode poison reduction system of claim 1, wherein the controller controls power generation of the fuel cell by changing a fuel cell request current to oscillate in the first control.

10. The anode poison reduction system of claim 9, wherein the controller, in the first control, increases pressure or a flow rate of air that is supplied to the cathode through the air line, and selectively changes a request current of the fuel cell to oscillate, depending on a charged amount of a battery that provides driving power for the vehicle.

11. The anode poison reduction system of claim 1, wherein the anode poisoning generation condition is determined on a basis of a decline in an inclination of an output voltage of the fuel cell.

12. The anode poison reduction system of claim 1, wherein the controller determines the anode poisoning generation condition when a decline in an inclination of an output voltage of the fuel cell is larger than a reference inclination in a reference current density period.

13. The anode poison reduction system of claim 1, wherein the controller performs the second control when the anode poisoning generation condition is satisfied and operation of the fuel cell is stopped.

14. The anode poison reduction system of claim 13, further comprising a compressor, wherein the connection line includes at least one of a drain valve and a purge valve, and the controller drives the compressor such that air is supplied to the outlet of the anode while flowing backward through the drain valve or the purge valve when performing the second control.

15. An anode poison reduction method for a fuel cell vehicle, the anode poison reduction method comprising:
monitoring, by a monitoring device, a state and performance of a fuel cell;
determining, by a controller, an anode poisoning possibility condition and performing, by the controller, first control of controlling output of the fuel cell or air supply when the anode poisoning possibility condition is satisfied; and
determining, by the controller, an anode poisoning generation condition and performing, by the controller, second control of supplying air in an air line to an anode through a connection line when the anode poisoning generation condition is satisfied.
